(19) United States
(12) Patent Application Publication
(10) Pub. No.: US 2003/0065522 A1
(43) Pub. Date: Apr. 3, 2003

(54) Electronic system for equipment maintenance and repair orders

(76) Inventors: John Wepfer, Orlando Park, IL (US); Cindy Lawbaugh, Monee, IL (US); James Roberts, Algonquin, IL (US)

Correspondence Address: Steven G. Steger, Mayer, Brown & Platt, P.O. Box 2828, Chicago, IL, 60690, US

(21) Appl. No.: 09/968,363

(22) Filed: Oct. 1, 2001

(51) Int. Cl. G06F 17/60

(52) U.S. Cl. 705/1

(57) ABSTRACT

A computer maintenance and repair network is disclosed that is used to manage the activities of a network of service technicians and to coordinate equipment maintenance and repair service orders and subsequent invoices to customers. In this computer network, service and repair data is gathered, service orders are assigned, information about work performed by service technicians is entered, customer signatures are captured, and data is generated and exported to a central computer wherein it can be combined with other data and used for a number of purposes.

### BACKGROUND

1. Field of the Invention

The present invention relates generally to a system for managing service orders for equipment maintenance and repair and, more specifically, to a networked computing system for managing orders for equipment maintenance and repair.

2. Description of Related Art

The maintenance and repair of equipment is often conducted by a network of service technicians. In the past, such a network of service technicians has been controlled and monitored through the use of paper service orders to assign and monitor maintenance or repair tasks. When maintenance or repair of equipment was needed, the work was assigned to a specific technician. After the work was performed, the technician was required to prepare written report describing the work performed, date and time of work, part numbers used, description of any follow-up work deemed necessary, and any issues or questions regarding work performed. Also, a customer signature was obtained verifying that the work was performed to the customer's satisfaction.

An invoice charging for the work performed was then prepared and forwarded to the customer. This type of paper system of documentation to monitor and control maintenance and repair activity generates a large volume of paperwork that must be managed and stored, as well as physically transported from the technician in the field to a central location.

The above described type of system incorporating paper work orders, written work reports, and paper invoices, and the subsequent large volume of paperwork, results in a number of problems. For example, the large volume of paper documents requires substantial physical storage space, increases costs related to data entry clerks spending time keying manually written service orders and work reports and the subsequent time spent correcting errors in the data entry, significantly delays gathering information from technicians resulting from the required physical transportation of the documents, incomplete entry of information on written reports due to the inconvenience of handwriting the information, and delays in inventory control related to parts and/or components used by the technician that are not automatically input into an inventory control system.

Furthermore, the delay in transfer of physical documents creates a greater length of time between the performance of work and the review of the documents, making it more difficult to obtain accurate answers to any questions that arise regarding the work performed. Also, the delay of transfer of physical documents creates a negative impact on the cash flow of the maintenance and repair business because the time between the actual repair service and the final processing of the information delays the creation and sending of invoices. Compounding this problem, some customers require invoicing of repairs within a certain amount of time after the work has been completed. If this time is exceeded, collection on the invoice can become difficult.

Therefore, there is a need for a system to manage orders for equipment maintenance and repair in which the volume of paper documents to be completed and transferred is reduced, data accuracy is increased, and the transfer of information occurs in a faster and more efficient fashion.

### SUMMARY

The purpose and advantages of the invention will be set forth in, and apparent from, the description and drawings that follow, as well as will be learned through practice of the invention. Additional advantages of the invention will be realized and attained by the elements of the physical embodiment of the invention and methods of using the invention described herein.

In accordance with one aspect of the present invention, a computer maintenance and repair network is used to manage the activities of a network of service technicians and to coordinate equipment maintenance and repair service orders and subsequent invoices to customers. In this computer network, service and repair data is gathered, service orders are assigned, information about work performed by service technicians is entered, customer signatures are captured, and data is generated and exported to a central computer wherein it can be combined with other data and used for a number of purposes.

Orders for maintenance or repair work are input into the maintenance and repair network, including a description of the customer requesting work, the work desired, the location, and the timing of the work. The maintenance and repair network then assigns the service order to a service technician. This assignment can be done either manually or through a computerized assignment system.

When the work order has been assigned to a service technician, the technician performs the work as has been done in the past. Rather than prepare a handwritten summary of the work, however, the service technician inputs information into the maintenance and repair network through a work station, such as a mobile unit. This work station can be mobile, such as a pen-based, hand-held computer, a notebook computer, or any other portable computer, or the work station can be stationary, such as a desktop personal computer, or any other type of input device suitable to transmit information to the maintenance and repair network.

The technician is prompted to enter information such as work performed, parts used, job related employee expenses (i.e. travel, mileage), service details, date and time of repair, equipment and/or machine identification, length of time worked on project, a safety checklist, or any other information that is desirable to be captured about service or maintenance work for equipment. Various screens are accessed by the technician by clicking tabs on the screen of the mobile unit. These various screens provide and gather information as described further below. After the work is completed and the information is entered, the customer signature (indicating completion of and acceptance of work performed) can be captured directly in the mobile unit.

In a preferred embodiment, the description of the repair work is captured through a series of codes that are defined specifically to the model of machine being repaired. The technician is able to simply select the codes that describe the repair performed through a series of choices. The system virtually eliminates the need for the technician to handwrite a lengthy recap of all of the work performed. Such handwritten paragraphs are time-consuming to prepare and difficult to retrieve for later analysis. The system also provides the central computer with concise information that can be used by service and product support personnel for analyzing future equipment or machine failures. The work done can be stored in a number of different formats such as by task, by technician, or by machine id. This information is then available to generate various reports and to search using query functions.

After the technician has finished entering the information into the mobile unit, the unit communicates with the central computer in a manner known in the art (i.e., cellular network connection, radio frequency connection, global computer network connection, or connection through a local area network) to transmit the information to the central computer. In the preferred embodiment, the information is passed from the mobile units through a file transfer protocol (ftp) system, and then on to the central computer. However, the connection between the mobile units and the central computer can also be a direct connection. After the information from the individual technicians is transferred to the central computer, the information can be used for a variety of applications. Some examples include customer billing, inventory control, cost reporting, vendor processing and accounts payable, payroll and labor distribution.

These and other features and advantages of the invention will be apparent upon consideration of the following detailed description of the presently preferred embodiments of the invention, taken in conjunction with the claims and appended drawings, as well as will be learned through the practice of the invention.

### BRIEF DESCRIPTION OF THE DRAWINGS

FIG. 1 is a block diagram of an electronic system for equipment maintenance and repair orders in accordance with an embodiment of the present invention;

FIG. 2 is a logic flow diagram of the service technician data entry functions of an electronic system for equipment maintenance and repair orders in accordance with an embodiment of the present invention;

FIG. 3 is a logic flow diagram of the data transfer functions of an electronic system for equipment maintenance and repair orders in accordance with an embodiment of the present invention;

FIG. 4 is an illustration of a customer screen on a mobile unit of an electronic system for equipment maintenance and repair orders in accordance with an embodiment of the present invention;

FIG. 5 is an illustration of a header screen on a mobile unit of an electronic system for equipment maintenance and repair orders in accordance with an embodiment of the present invention;

FIG. 6 is an illustration of an instructions screen on a mobile unit of an electronic system for equipment maintenance and repair orders in accordance with an embodiment of the present invention;

FIG. 7 is an illustration of a materials screen on a mobile unit of an electronic system for equipment maintenance and repair orders in accordance with an embodiment of the present invention;

FIG. 8 is an illustration of a labor screen on a mobile unit of an electronic system for equipment maintenance and repair orders in accordance with an embodiment of the present invention;

FIG. 9 is an illustration of a work performed screen on a mobile unit of an electronic system for equipment maintenance and repair orders in accordance with an embodiment of the present invention;

FIG. 10 is an illustration of an outside vendor screen on a mobile unit of an electronic system for equipment maintenance and repair orders in accordance with an embodiment of the present invention;

FIG. 11 is an illustration of an expenses screen on a mobile unit of an electronic system for equipment maintenance and repair orders in accordance with an embodiment of the present invention;

FIG. 12 is an illustration of a comments screen on a mobile unit of an electronic system for equipment maintenance and repair orders in accordance with an embodiment of the present invention; and

FIG. 13 is an illustration of a safety checklist screen on a mobile unit of an electronic system for equipment maintenance and repair orders in accordance with an embodiment of the present invention.

### DESCRIPTION OF THE PREFERRED EMBODIMENTS

While the invention can be embodied in many different forms, there is shown in the drawings, and will herein be described in detail, a preferred embodiment of the present invention with the understanding that the present disclosure is to be considered as an exemplification of the principles of the invention and is not intended to limit the invention to the embodiments illustrated.

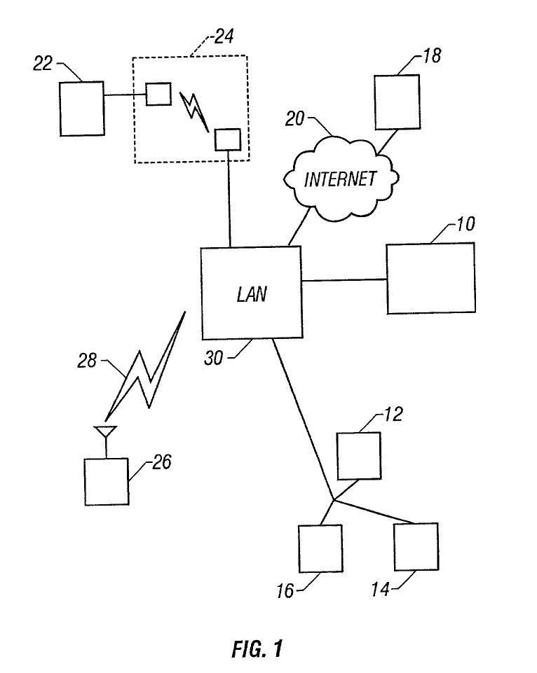

Referring now to FIG. 1, a block diagram an electronic system for equipment maintenance and repair orders in accordance with an embodiment of the present invention is shown. The system comprises a central computer 10 on which information is stored and which controls the transfer of information throughout the system. The central computer 10 is preferably a personal computer, however, any type of computer with sufficient memory and processing power can be used.

Also shown in FIG. 1 are a number of mobile units connected to the central computer 10 in a number of different ways. The connection of the mobile units to the central computer 10 can include, for example: computers 12, 14 and 16 that are connected to central computer 10 directly via a local area network (LAN) 30; computer 18 that is connected to the LAN 30 via the global computer network 20, also known as the Internet, and then through the LAN 30 to the central computer 10; computer 22 that is connected to the LAN 30 via remote communication through the airwaves (e.g. CDMA, GSM, GPRS or a cellular connection through the global computer network (CDPD)) generally designated as 24, and then through the LAN 30 to the central computer 10; and a computer 26 that is connected to the LAN 30 via a radio frequency (RF) link 28, and through the LAN 30 to the central computer 10. It should be noted that any of the mobile units can also be connected directly to the central computer 10 via any of the above communication links without first passing through the LAN 30.

The computers that comprise the mobile units can be personal computers, notebook computers, handheld computers, or any other type of computer with sufficient memory and processing power. Furthermore, any communication link between the mobile units and the central computer 10 that allows for transfer of data can be used in accordance with the present invention.

In a preferred embodiment, handheld computing devices 26 are used as the mobile units and are connected to the central computer 10 through the LAN 30 via a communication link. The technicians using the mobile units enter details related to an equipment repair or maintenance service order via the mobile units in place of handwritten, manual work orders. Labor, parts used, job related employee expenses (i.e. travel, mileage) and any additional service details are entered into the system via the mobile unit, as described further below. The date and time of service, machine identification, length of repair work, and safety check list are also contained on the order entry screen of the mobile units. The customer signature can also be captured on the mobile unit via techniques that are known in the art.

A description of the repair or service work performed is captured by the mobile unit through a series of work codes that are defined specifically for the model of equipment or machine being serviced or repaired. The technicians are able to simply select the codes that describe the repair work through a series of list boxes on the screen of the mobile unit, as described below. The information can then be transmitted to the central computer 10 via the LAN 30 for storage and integration into other software applications such as customer billing, inventory control, cost reporting, vendor processing and accounts payable, payroll and labor distribution.

In an alternate embodiment, desktop personal computers connected to the central computer 10 via either the LAN 30 or directly through the global computer network are used for technicians operating in a shop environment. Furthermore, in an alternate embodiment, a printer can be included so that a printed copy of the service order form is available if desired.

When the system software is installed on the mobile unit, whether it is a desktop personal computer, a handheld computer, a laptop computer, or other type of computer, the mobile unit is assigned a specific user id and password. The unique password must be entered to access the system. Furthermore, in the preferred embodiment, each technician in the system is associated with a mobile unit, and thus, with a user id and a password.

In alternate embodiments, a single mobile unit can be used by multiple technicians, wherein each technician has his or her own user id, and there is a single password for the mobile unit with each technician logging onto the mobile unit using the same password. Also, a single technician may have multiple mobile units assigned to the technician, such as, for example, a technician using a desktop personal computer when working in a shop and also using a handheld computer when performing work in the field. Finally, multiple technicians can share multiple mobile units. For example, a number of technicians may work in the same shop and the shop may be equipped with two or more mobile units. Any one of the technicians can use any one of the machines. As mentioned above, each technician has his or her own unique user id, and each machine has a distinct password used by all technicians.

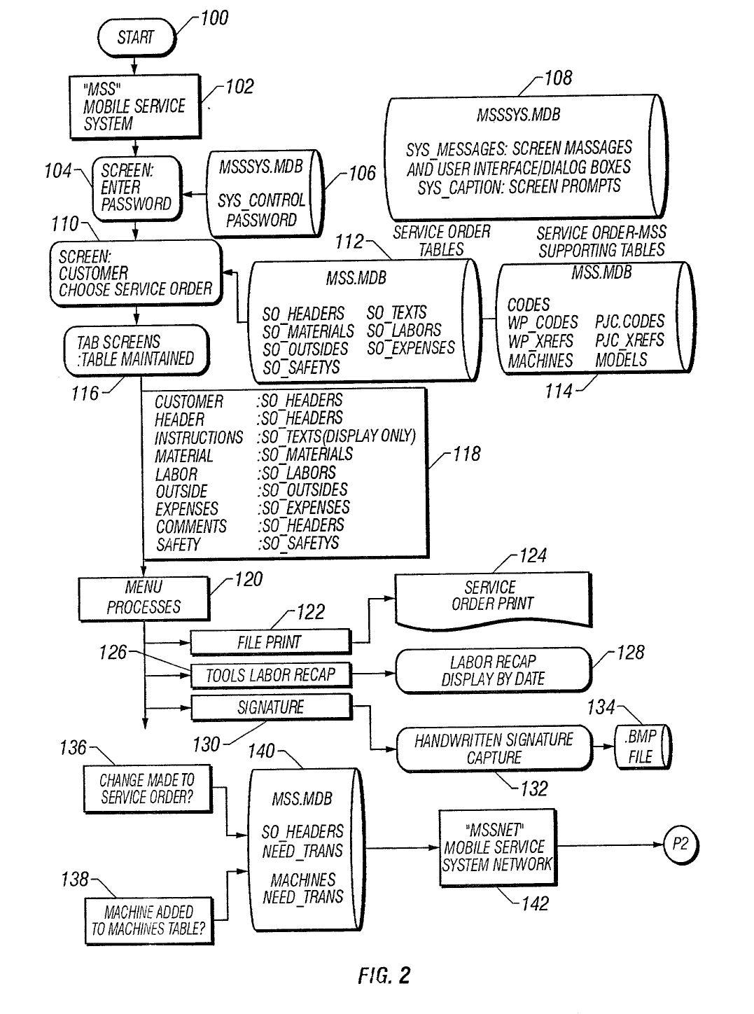

Referring now to FIG. 2, a flow diagram is shown illustrating the steps of the system through a series of screens that allow the technicians to control the flow of information to and from the mobile units. The screens allow the flexibility of incorporating messages and/or default information on the screens of the mobile units. The system is started when the mobile unit is powered up at step 100. At step 102, the mobile service system start screen is displayed, including, if desired, an orientation screen. Next, at step 104, the technician is prompted to enter his or her password that is associated with the specific user id and mobile unit associated with the technician.

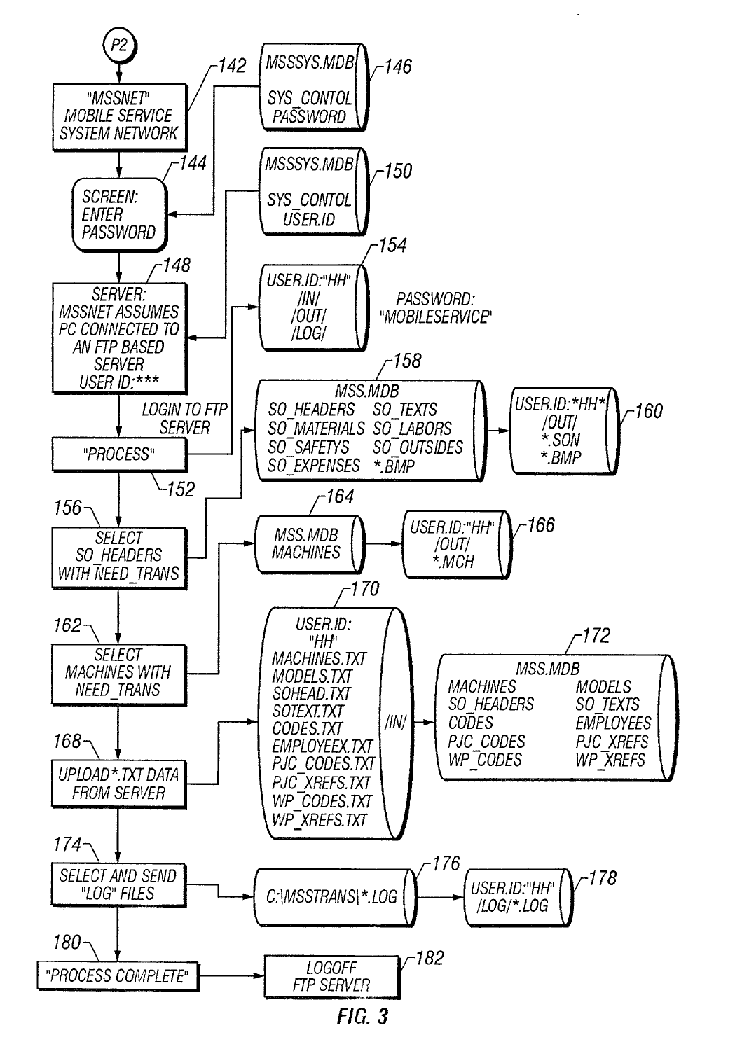

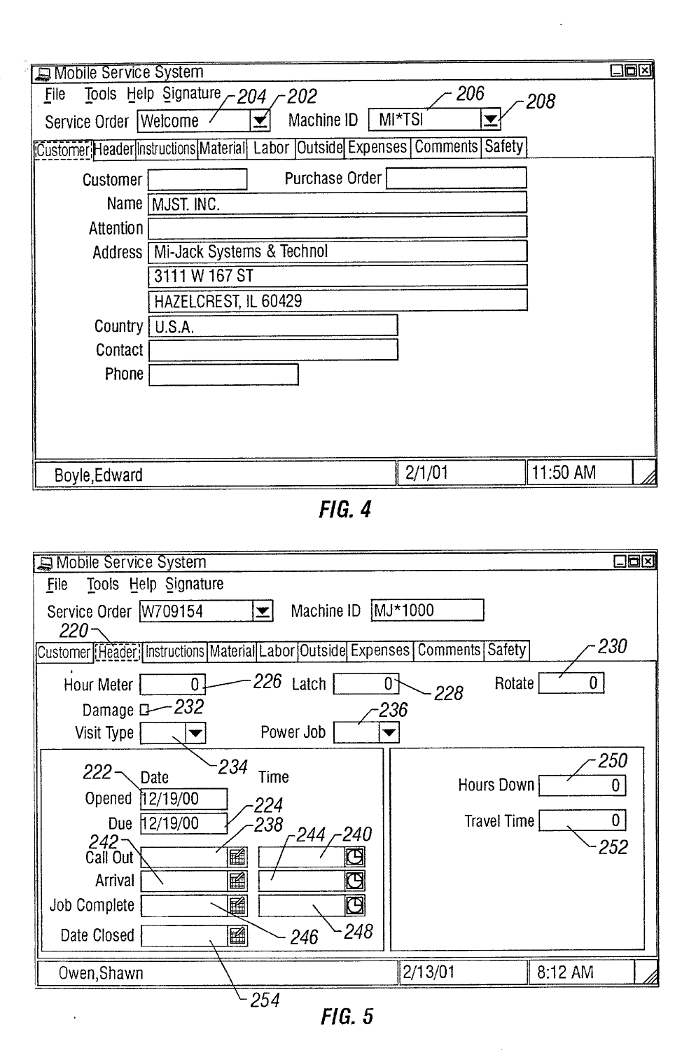

The system is then consulted at step 106 to determine whether the user is authorized and to verify that the correct password has been entered. When a valid password is entered at step 104, the system presents the standard service order customer screen, shown in FIG. 4. In an alternate embodiment, at step 108, messages and information can be displayed on the screens of the mobile unit prior to the display of the customer screen. Also, as a further alternate embodiment, a touch keyboard on the screen of the mobile unit can be included and used by the technician when activated, as is known in the art. This allows a handheld computing unit that does not incorporate a full keyboard to perform the full functionality of the system, further reducing the size of the handheld unit.

At the next step 110, customer and service order information is supplied to the technician at the customer screen. The system automatically recalls the previously accessed customer and service order, and automatically starts at customer tab 200. To retrieve a different order, the technician clicks the arrow 202 next to the service order box 204, shown in FIG. 4. A list of all orders currently stored in the database is displayed. The desired service order can be entered via the keyboard or the touchpad screen, or the stored orders can be scrolled through to located and choose the desired order from the list. This list of orders can be displayed in customer, machine id, order number, or date due sequence, either in ascending or descending order. Also, the system can be set so that only open orders are displayed, or alternatively, so that all orders are displayed. Finally, which orders can be displayed on which mobile units is predetermined by the system administrator. For example, the system can be restricted so that only orders that are assigned to a specific technician can be accessed by the mobile unit assigned to that technician.

Information about the service order chosen by the technician is retrieved from service order table 112 and supporting tables 114. These tables 112 and 114 include information such as materials, instructions, labor, expenses, safety information, comments, etc., which are described further below. At step 116, multiple screens can be tabbed through by the service technician such that the technician can receive information on some screens (such as instructions), input information on some screens (such as material, labor, other outside information, expenses, miscellaneous comments, safety information, warranty information, etc.), and receive and input information on some screens (such as customer data or header data), as described in 118. As the technician tabs through the screens at step 118, the technician enters applicable information regarding work performed by the technician. The information entered is stored by the mobile unit and ultimately transmitted to the central computer for uses such as those described above.

A new service order can be added to the system by selecting a new order function when the list of service orders is displayed. When a new service order is created, a service order number will be assigned to the service order. In the preferred embodiment, the service order number will contain a specific mobile unit number that is unique to the mobile unit through which the new service order is entered plus a four digit sequentially assigned number. After the new service order number is assigned, the technician selects the machine that is being repaired from the machine id box 206. To view a list of all machines currently incorporated into the database, the technician can click the arrow 208 next to the machine id box 206. The technician can then scroll through the list of machines and select the specific machine being serviced. The technician will then be prompted to fill out the customer information screen inserting all information regarding the specific customer for whom the new service order is being created, as shown in FIG. 4.

The technician can also add a new machine to the machine database by selecting the add function when scrolling through the machine id list. To add a new machine, the technician fills out the fields on the machine screen and saves the information on the mobile unit. When the new machine has been added to the machine database, the machine will then appear on the machine id list.

After the technician has selected the appropriate service order and machine id, either by selecting an existing service order and related machine id or by entering information about a new service order and machine id, the technician is ready to enter information about the work related to the service order that has been assigned to the technician. This entry of information begins with the input of information requested in the header screen, which is shown in FIG. 5.

Referring to FIG. 5, when the header tab 220 is clicked, a screen having various fields is displayed. All fields on the screen should be filled during work on the applicable service order. The header screen shown in FIG. 5 consists of basic information relative to the repair order and the machine that is being repaired. In the preferred embodiment, information in the fields for the date that the repair order was opened in open date box 222 and the date when the completion of the order is due in date due box 224 has already been inserted by the central computer 10, and is not 10 accessible by the technician through the mobile unit.

Referring further to FIG. 5, information about the machine being serviced is entered by the technician during inspection of the machine being serviced or repaired. The hour meter reading of the machine is entered at hour meter box 226. The latch count reading of the machine is entered at the latch box 228, if applicable. The rotate count reading of the machine is entered at rotate box 230, if applicable. If the repairs required to the machine are the result of damage, damage box 230 is checked by the technician. Next, the visit type code is entered in visit type box 234. Standard visit type codes can be incorporated in the system such as: courtesy call; callout; erection; load transfer; manufacturer's rework; preventative maintenance; scheduled service; watchdog; or any other standard visit type code desired by the user that has been programmed into the system.

In a preferred embodiment, a power job box 236 is incorporated in the header screen. The power job box 236 is used to flag the order if a customer specific job code is required for all detailed records on the service order for that the customer. The customer specific job code is available for any customer job code tables that have been installed in the system database. If one of the customer specific job codes is selected in the power job field, the specific customer's job codes will be available for the various fields on the mobile unit in addition to the standard job codes. This function is optional and is not required for the operation of the mobile unit or the system.

The next area on the header screen shown in FIG. 5 are the boxes specifically related to the repair work. As discussed above, the date opened box 222 and date due box 224 are generally not accessible by the technician using a mobile unit. In the callout boxes 238 and 240, the technician enters the date and time of the start of the job. In the arrival boxes 242 and 244, the technician enters the date and time of arrival at the job site. In the job completed boxes 246 and 248, the technician enters the date and time of completion of the job. In the hours down box 250, the technician enters the number of hours the machine was actually out of service during repair work. In the travel time box 252, the technician enters the number of travel hours both to and from the job site. Finally, in the date closed box 254, the technician enters a date when all entries in the system for this order are complete. In the preferred embodiment, the date closed will not be able to be entered into box 254 until all fields have been completed, most notably the safety inspection screen and related fields described further below.

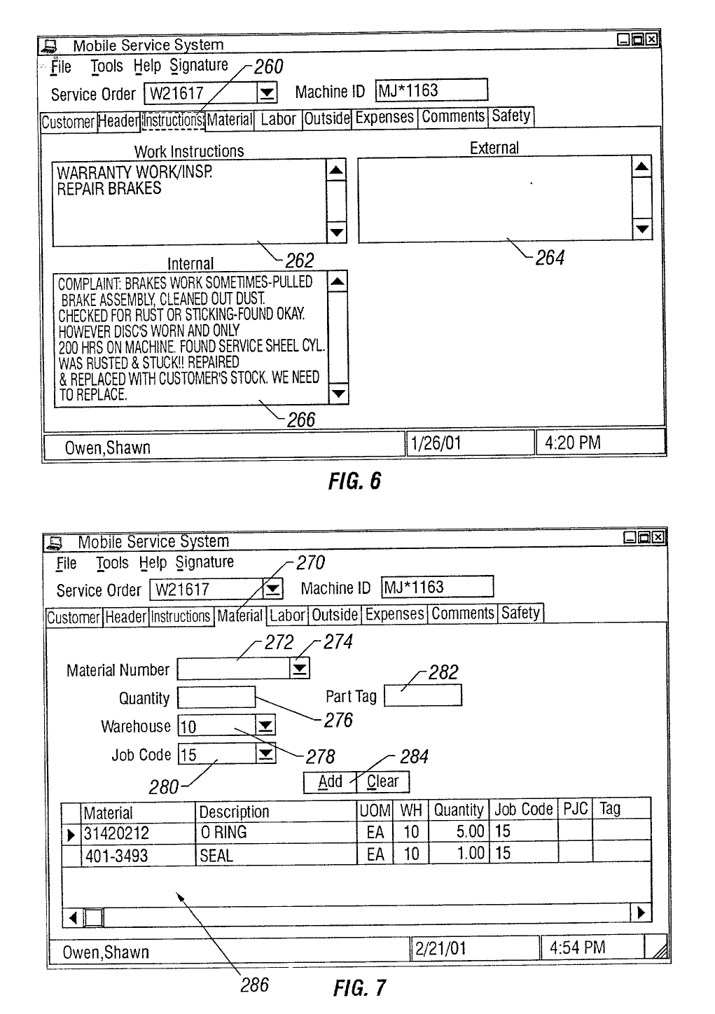

Referring now to FIG. 6, the instructions screen of the mobile unit is shown. The instructions screen is accessed when the technician clicks the instructions tab 260 on the mobile unit screen. This instructions screen contains information that is transmitted from the central computer 10 to the individual mobile unit. The instructions screen is an inquiry only screen, and cannot be modified by the technician at the mobile unit. Work instructions for the technician will be displayed here. The technician should review the instructions screen when accessing the service order to read any special instructions regarding the job. As an alternate embodiment, this screen can automatically be displayed on the mobile unit when the technician accesses any service order. There are three main text areas on the instructions screen. The first is the work instructions box 262 which includes a brief description of required repairs. The descriptions in the work instructions box 262 are based on a standardized table on the central computer 10.

The next box is the external instructions box 264. This box allows free entry of text at the central computer 10 for review by the technician on the mobile unit. The data that is contained in this external instructions box 264 appears on any printouts of the service order and on the customer invoice. The next box is the internal instructions box 266. This box also allows free entry of text at the central computer 10 for review by the technician. However, the data that is contained in the internal instructions box 266 does not appear on printouts of the service order or on the customer invoice.

Referring now to FIG. 7, the material screen of the mobile unit is illustrated. The technician can access the material screen by clicking the material tab 270. Parts and materials used by the technician in performing work for a service order are entered into the material screen. A master parts file is included in the system and is used to search for specific material or parts numbers. Information entered on the material screen is transferred to the central computer 10 through the system network as described above, and the information can be used for a variety of inventory applications such as inventory control and cost tracking.

The material screen includes a material number box 272, in which the technician inserts the part number used. In an alternate embodiment, a bar code reader may be included with the mobile unit so that the technician can simply scan the item being used rather than manually enter the part number. The technician can also click the arrow 274 next to the material number box 272 to scroll through a list of parts from the parts data file. The part number entered by the technician must be a valid part number from the database or the system will not accept the part number entered.

After the technician has entered the part number in box 272, the quantity of parts used is entered in quantity box 276. The unit of measure (UOM) appears on the detailed display area 286 on the lower portion of the screen, which will be described further below.

Next, the technician enters the warehouse from which the material or parts will be received in the warehouse box 278. This information can then be used by the central computer to deduct that inventory from the warehouse database. In a preferred embodiment, each technician is assigned a specific warehouse from which the technician generally receives materials and parts. Thus, for that technician's mobile unit, the warehouse number to which the technician is assigned is automatically entered by default in the warehouse box 278. This default value can be changed by the technician if it is necessary to obtain materials or parts from an alternate warehouse.

The job code box 280 is filled in by the technician to indicate how the specific line item being entered will be charged. Depending on the code entered in the job code box 280, the customer may be invoiced for the parts or material used, or the charge may be internal to the company performing the repair work. For example, entering job code 1 will generate a customer invoice. Additional codes can be incorporated into the system to more specifically indicate the type of charge for the specific part or material. These codes are then sent to the central computer 10 for invoicing.

Finally, the part tag box 282 allows the technician to enter the tracking number of a tag attached by the technician to any failed part or material on the machine to be repaired that requires repair or service due to failure, wear, or other factors. This information can then be sent to the central computer 10 for further use in tracking failed parts and analyzing failure of specific machines. A value is only entered in box 282 for failed parts or materials that are being returned for replacement or repair.

After the above information has been entered, the technician clicks the add button 284 to add the part or material information to the detailed display area portion of the screen 286. For each material or part number entered by the technician, a separate line item is generated in the detailed display area 286. The line items can then be deleted or modified by clicking on the specific line item, which will display the specific material or part in to the boxes as described above. These boxes can then be modified and resaved.

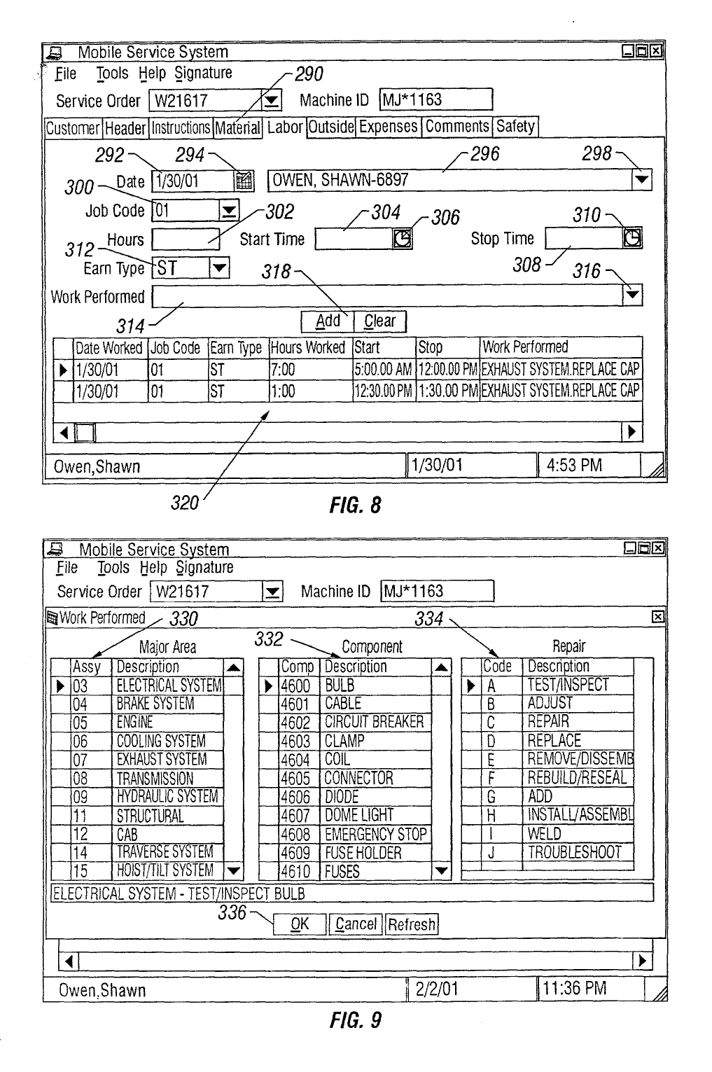

Referring now to FIG. 8, the labor screen of the system is shown. The labor screen is accessed by the technician by clicking labor tab 290. This screen allows the technician to enter work performed by the technician in response to the service order. In the preferred embodiment, a series of codes describing types of work performed is included in the database to allow the technician to enter work performed through the use of codes, rather than requiring the technician to input a detailed description of the work performed. These codes build a narrative of the repair for printing on the service order that is far more detailed then what is conventionally entered through handwritten reports of work performed. The data is also sent to the central computer 10 for later analysis of machine failure and to monitor a machine repair order history for both the specific machine and for the technician performing the repair. Also, the technician's hours are entered on the labor screen, allowing technicians and the company to track the work of technicians who are paid by the hour.

The technician enters the date of performance of the repair labor in the date box 292. This box defaults to the current date when entering information. If the technician is entering information about work performed on a date other than the current date, the default information in the date box 292 can be modified either by typing an alternate date directly into the date box 292 or by clicking on the calendar icon 294 next to the date box 292 to select the proper date from a calendar displayed on the screen.

The technician also enters the person who performed the work in the technician box 296. The technician contained in technician box 296 will default to the technician who has been assigned to the specific mobile unit being used. The technician can change the individual shown in this box either by typing a different technician's name directly into the technician box 296 or by clicking on the arrow 298 next to the technician box 296 to view a list of technicians in the system database and selecting one of the listed technicians.

The job code box 300 is filled in by the technician to indicate how the specific line item being entered will be charged. Depending on the code entered in the job code box 300, the customer may be invoiced for the labor performed or the charge may be internal to the company providing the labor. For example, entering job code 1 will generate a customer invoice. Additional codes can be incorporated into the system to more specifically indicate the type of charge for the specific labor performed. These codes are then sent to the central computer for invoicing.

The technician can enter the hours worked in performing the specific labor for the work order in hours box 302. This box may also be filled by the system automatically based on the calculated hours between start time and stop time entered as described below. It is preferred to allow the system to calculate the hours worked, rather than having the technician directly enter information in the hours box 302.

The start time box 304 allows the technician to enter the starting time of the labor line item being entered. While the technician can directly enter the start time, the preferred method of entering the start time is to click on the clock icon 306 located next to the start time box 304. When the clock icon 306 is clicked, the current time is automatically entered into the start time box 304. The system can be set for any minimum increment of time (such as fifteen minutes), and the start time will automatically entered as being the immediately previous time increment.

The stop time box 308 allows the technician to enter the ending time of the labor line item being entered. As described with respect to the start time box 304, the stop time box 308 allows for input of the stop time directly by the technician or allows the technician to click the clock icon 310 next to the stop time box 308 to automatically enter the current time into the stop time box 308. Also as described with respect to the start time box 304, predetermined increments of time can be incorporated into the system so that when the clock icon 310 is clicked, the next increment of time is entered into stop time box 308.

The automatic calculation of time for the hours box 302 will occur after the time in the stop time box 308 is entered. In the preferred embodiment, if a number of hours was previously entered in the hours box 302, that number will be replaced by the actual number between start time and stop time when the time is entered into stop time box 308. The earn type box 312 allows the technician to enter the earn type of the work performed, such as standard time, overtime, or double time. The default for this box is standard time.

Work performed box 314 allows the technician to enter a description of the work performed by the technician. In the preferred operation of the system, the technician will click the arrow 316 next to the work performed box 314 to reach the detailed work performed screen, which is shown in FIG. 9. The detailed work performed screen includes three fields, the major area field 330, the component field 332, and the repair field 334. The descriptions contained in these fields can be selected by the technician to create a detailed description of the work performed by simply clicking on the desired description in the fields.

The information contained in the fields on the work performed screen are specific to the machine make and model that was selected with respect to the initial screen illustrated in FIG. 5. The technician will first select the major area of the machine that the work was performed on in major area list 330. When the major area of repair work is selected the component list 332 will change to those components associated with the selected major area. The technician will then select the component to which repair work was performed from the component list 332. The technician will then select the appropriate type of repair from the repair list 334. In the preferred embodiment, this repair list 334 is not dependent upon the major area selected or the component selected, and will not change based on these selections. However, in an alternate embodiment, the specific type of repair work list 334 may be specific to the component and major area chosen by the technician.

When the desired major area, component, and repair type are selected, the technician clicks the OK button 336 to return to the labor screen illustrated in FIG. 8. The work performed box 314 will then be filled with the selections made in the detailed work performed screen described above.

After the above information has been entered, the technician clicks the add button 318 to add the labor information to the detailed display area portion of the screen 320. For each labor task entered by the technician, a separate line item is generated in the detailed display area 320. The line items can then be deleted or modified by clicking on the specific line item, which will recall the labor description to the boxes on the screen as described above. These boxes can then be modified and resaved.

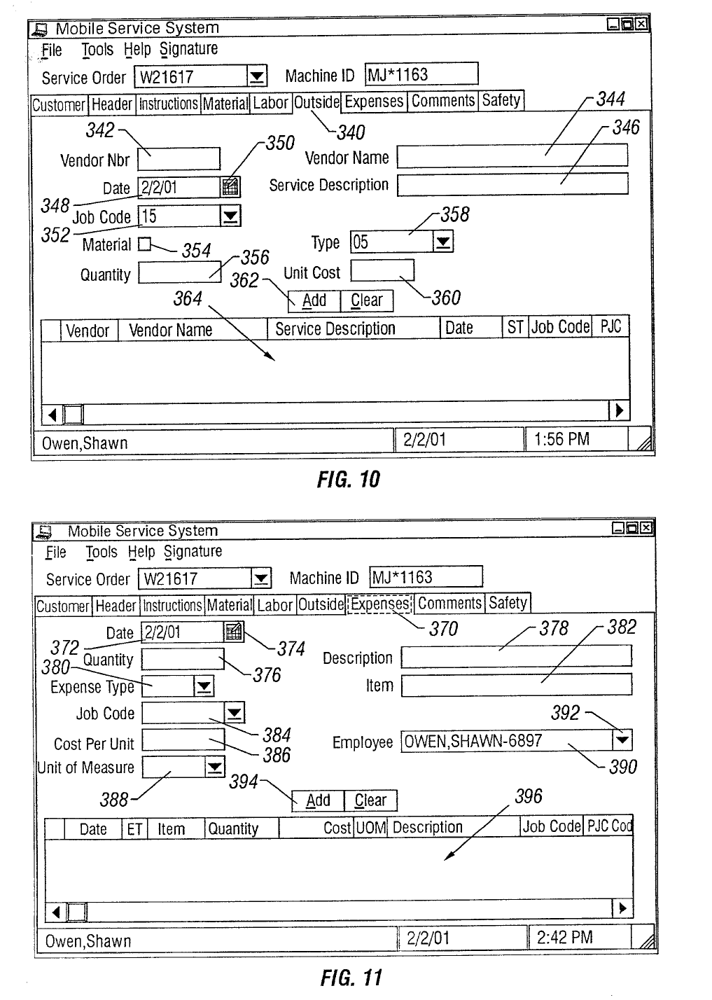

Referring now to FIG. 10, the outside screen of the system is shown. The technician accesses the outside screen by clicking outside tab 340. Through the outside screen, the technician is able to enter outside services and/or vendor work that is sometimes used in performing work under service orders. The services entered through this screen can be transferred to the central computer 10 where the invoice from the outside vendor and subsequent payments to the vendor and billing to the customer can be handled.

The technician enters the vendor number in vendor number box 342 if the technician knows the vendor number. In the preferred embodiment, there is no validation of the vendor number that is entered and entry of a vendor number is not required. The technician also enters the name of the vendor in the vendor name box 344, and a description of the service provided by the vendor in service description box 346. The technician enters the date of the outside service in date box 348. The date box 348 will automatically show the current date, so if entry is being made on the date of the outside service, no additional entry is necessary. If the date needs to be changed, the technician can either directly enter the date into the date box 348 or click the calendar icon 350 next to the date box 348 and select the proper date from the display calendar.

The job code box 352 is filled in by the technician to indicate how the specific line item being entered will be charged. Depending on the code entered in the job code box 352, the customer may be invoiced for the outside services or the charge may be internal to the company providing the labor. For example, entering job code 1 will generate a customer invoice. Additional codes can be incorporated into the system to more specifically indicate the type of charge for the outside service performed. These codes are then sent to the central computer 10 for invoicing.

If the line item being entered is material purchased rather than outside service performed material box 354 is checked by the technician. This box is useful for determining whether the line item must be taxed (in some states, materials are taxed, while service is not). However, whether or not the line item is material or outside service, the quantity of material purchased is entered in quantity box 356. If the line item is for an outside service, “1” will be entered in the quantity box 356. The type of line item charged is entered in type box 358, and can be selected from a number of predetermined codes, such as outside service or freight for equipment. Finally, the unit cost is entered in unit cost box 360 for the material or service performed.

After the above information has been entered, the technician clicks the add button 362 to add the outside information to the detailed display area portion of the screen 364. For each outside service entered by the technician, a separate line item is generated in the detailed display area 364. The line items can then be deleted or modified by clicking on the specific line item, which will recall the outside description to the boxes on the screen as described above. These boxes can then be modified and resaved.

Referring now to FIG. 11, the expenses screen of the system is shown. The technician accesses this screen by clicking the expenses tab 370 to enter expenses directly associated with the service order. The expenses screen also allows for entry of material purchased for the service order that is not taken from inventory, such as material purchased directly by the technician at a retail store. The technician enters the date that the expense was incurred in date box 372. The date box 372 will automatically show the current date, so if entry is being made on the date of the expense, no entry is necessary. If the date needs to be changed, the technician can either directly enter the date into the date box 372, or click the calendar icon 374 next to the date box 372 and select the proper date from the display calendar.

The technician then enters the quantity purchased in quantity box 376, along with a description of the item purchased in the description box 378. The technician enters the expense type in expense box 380. The system includes a list of codes of expense type such as freight, lodging, local parts (purchased by technician), fuel surcharge, per diem, and travel. Any other type of expense can be added to the list of codes used by the system. When the expense type is selected a description of the type will be entered in item box 382. This description can be modified by the technician as desired.

The job code box 384 is filled in by the technician to indicate how the specific line item being entered will be charged. Depending on the code entered in the job code box 384, the customer may be invoiced for the expense or the charge may be internal to the company providing the labor. For example, entering job code 1 will generate a customer invoice. Additional codes can be incorporated into the system to more specifically indicate the type of charge for the expense incurred. These codes are then sent to the central computer 10 for invoicing.

The technician will also enter the cost per unit for the expense in the cost per unit box 386, as well as the unit of measure of this expense in unit of measure box 388.

The technician also enters the person who incurred the expense in the technician box 390. The technician name in technician box 390 defaults to the technician who has been assigned to the specific mobile unit being used. The technician can change the individual shown in this box either by typing a different technician's name directly into the box or by clicking on the arrow 392 next to the technician box 390 to vew a list of technicians in the system database and selecting one of the listed technicians.

After the above information has been entered, the technician clicks the add button 394 to add the expense information to the detailed display area portion of the screen 396. For each expense entered by the technician, a separate line item is generated in the detailed display area 396. The line items can then be deleted or modified by clicking on the specific line item, which will recall the expense description to the boxes on the screen as described above. These boxes can then be modified and resaved.

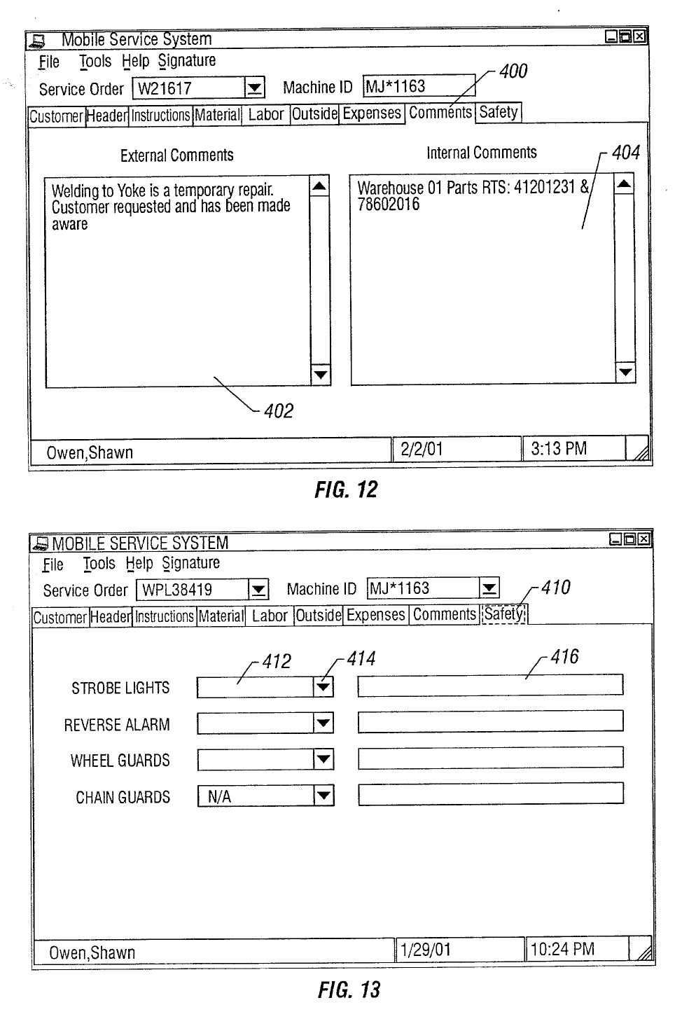

Referring now to FIG. 12, the comments screen of the system is shown. The technician accesses the comments screen by clicking the comments tab 400. The comments screen allows the technician to enter miscellaneous text and comments related to the service order. There are two areas for entering comments in this screen, the external comments area 402 and the internal comments area 404. When the technician clicks inside either of the two boxes 402 or 404, a keyboard window will be displayed which allows entry of text through the touchscreen keyboard. Information can also be entered through an external keyboard attached to the mobile unit. Text entered in external comments box 402 will appear on any printouts of the service order and on the customer invoice. Text entered into internal comments box 404 will not appear on the printouts of the service order for the customer invoice.

Referring now to FIG. 13, the safety screen is shown. The safety screen is accessed by the technician by clicking the safety tab 410. As a general rule, the specific items related to the safe operation of equipment must be inspected by the technician whenever a machine is worked on by that technician. To insure that this occurs, the safety screen must be accessed by the technician and the safety checklist must be filled in before completing the service order. In the preferred embodiment, neither the signature function nor the date closed function on the header screen will be allowed to be filled in until the safety screen has been completed. To complete the safety inspections, the technician consults a list of safety check items that are associated with the machine being service. As the technician inspects each item on the list, the technician clicks the arrow next to the box for that item (for example strobe light box 412 and associated arrow 414) for a list of inspection results. In the preferred embodiment, the technician chooses between the following conditions for the safety checklist: not applicable (N/A); operable; missing; damaged; or any other inspection result. The technician can then enter comments if necessary in the text box next to the safety check box (for example text box 416 in FIG. 13).

Other tabs can be incorporated into the system in accordance with the present invention. For example, a warranty tab can be included so that the technician can enter any warranty information associated with a service order. Additional tabs can be included that are specific to an industry or an application, and still fall within the present invention.

Referring again to FIG. 2, after the technician has accessed and entered any applicable information at step 118 by tabbing through the screens at step 116 as described above, the technician can access a number of menu processes at step 120. The technician can choose file print at step 122, which will print a service order incorporating the information the technician has entered. This service order can be retained by the technician for his or her records or supplied to the customer. The technician can also choose the tools labor recap function at step 126, and a recap of the labor performed and tools used by work order will be displayed on the mobile unit screen at step 128. The technician can also request the customer signature at step 130 verify that customer has accepted the work and considers the work to have been performed satisfactorily. The signature is captured by the mobile unit at step 132 and is stored as a .BMP file at step 134 for future reference.

At step 136, the mobile unit determines whether the technician has made any change to the service order (i.e. added and/or deleted information) and at step 138 the mobile unit determines whether a new machine is being serviced such that the machine must be added to the system's machines table, as described above with respect to a technician adding a new machine to the system. The mobile unit then provides any updated information arising from changes made to the service order and additional machines in the machine table to the service order tables 112 and 114. This information is then transmitted to the mobile service system network at step 142 and is supplied to the central computer 10 as discussed further above and below.

Referring now to FIG. 3, a flow diagram of the actions of the central computer is shown. The flow diagram of FIG. 3 begins at step 142, the transfer of information from the mobile unit to the central computer, which is also the last step shown in FIG. 2. When logging onto the mobile unit at step 144, the user must enter a password. The username and password are verified from the database as shown at step 146. At step 148, the server is connected to the mobile unit via file transfer protocol (FTP) through the LAN 30 and the mobile unit is identified at step 150 through the database. At step 152, information is sent from the mobile unit to the central computer. At step 154, information about the mobile unit is provided and at step 156, additional information input by the technician is transmitted to the central computer 10 and added to the central computer database at steps 158 and 160.

At step 162, the specific machines that were added are identified and updated at steps 164 and 166. At step 168, information is sent to the mobile unit regarding the specific machines being serviced, such as table data, machine information, part masters, technicians, job codes, and any other data information and master files, as shown at step 170. Additional information regarding the work to be performed is transmitted at step 172. At step 174, a transmission log record is transmitted to the central computer 10 and the central computer 10 stores information about the transmission at step 176 and 178. This is useful in diagnosing machine transmission errors. The process is completed at step 180 and the server is signed off at step 182.

It is to be understood that a wide range of changes and modifications to the embodiments described above will be apparent to those skilled in the art, and these changes and modifications are contemplated herein. It is, therefore, intended that the foregoing detailed description be regarded as illustrative rather than limiting, and that it be understood that it is the following claims, including all equivalents, that are intended to define the spirit and scope of the invention.

We claim:

1. An electronic system for monitoring and coordinating equipment maintenance or repair comprising:
a central computer; and
one or more mobile units that communicate with the central computer, wherein;
each mobile unit provides information to a technician regarding an equipment maintenance or repair project; and
the technician inputs information about the equipment maintenance or repair project to the mobile unit.

2. The system as claimed in claim 1, wherein the information provided to the technician regarding the equipment maintenance or repair project includes customer data, machine information, and repair or maintenance instructions.

3. The system as claimed in claim 2, wherein the information input by the technician regarding the equipment maintenance or repair project includes material used, labor performed, time worked, expenses, and safety inspection.

4. The system as described in claim 3, wherein the technician inputs information via a series of numerical codes.

5. The system as claimed in claim 1, wherein each mobile unit comprises a handheld, pen-based computer incorporating a touch screen.

6. The system as claimed in claim 5, wherein each mobile unit is adapted to receive and save a customer signature on the touch screen.

7. The system as claimed in claim 1, wherein each mobile unit communicates with the central computer through one or more of: a local area network; a global computer network; a radio frequency link; and a cellular technology link.

8. The system as claimed in claim 1, wherein the information provided to the technician by the mobile unit is received by the mobile unit from the central computer and the information input by the technician to the mobile unit is transmitted to the central computer.

9. The system as claimed in claim 8, wherein the central computer gathers information received from multiple mobile units and stores the information for use in one or more of: customer billing; inventory control; cost reporting; accounts payable; payroll; and labor distribution.

10. An electronic system for monitoring and coordinating equipment maintenance or repair comprising:
a central computer; and
multiple mobile units that communicate with the central computer, wherein;
each mobile unit provides information to a technician regarding an equipment maintenance or repair project, including customer data, machine information, and repair or maintenance instructions; and
the technician inputs information about the equipment maintenance or repair project to the mobile unit.

11. The system as claimed in claim 10, wherein the information input by the technician regarding the equipment maintenance or repair project includes material used, labor performed, time worked, expenses, and safety inspection.

12. The system as described in claim 11, wherein the technician inputs information via a series of numerical codes.

13. The system as claimed in claim 11, wherein each mobile unit comprises a handheld, pen-based computer incorporating a touch screen.

14. The system as claimed in claim 13, wherein each mobile unit is adapted to receive and save a customer signature on the touch screen.

15. The system as claimed in claim 10, wherein each mobile unit communicates with the central computer through one or more of: a local area network; a global computer network; a radio frequency link; and a cellular technology link.

16. The system as claimed in claim 15, wherein the information provided to the technician by the mobile unit is received by the mobile unit from the central computer and the information input by the technician to the mobile unit is transmitted to the central computer.

17. The system as claimed in claim 16, wherein the central computer gathers information received from multiple mobile units and stores the information for use in one or more of: customer billing; inventory control; cost reporting; accounts payable; payroll; and labor distribution.

18. An electronic system for monitoring and coordinating equipment maintenance or repair comprising:
a central computer; and
multiple mobile units that communicate with the central computer, wherein;
each mobile unit is assigned to a specific technician;
each mobile unit provides information to the technician regarding an equipment maintenance or repair project, including customer data, machine information, and repair or maintenance instructions; and
the technician inputs information about the equipment maintenance or repair project to the mobile unit including material used, labor performed, time worked, expenses, and safety inspection.

19. The system as claimed in claim 18, wherein each mobile unit comprises a handheld, pen-based computer incorporating a touch screen.

20. The system as claimed in claim 19, wherein each mobile unit communicates with the central computer through one or more of: a local area network; a global computer network; a radio frequency link; and a cellular technology link.

21. The system as claimed in claim 20, wherein the information provided to the technician by the mobile unit is received by the mobile unit from the central computer and the information input by the technician to the mobile unit is transmitted to the central computer.

22. The system as claimed in claim 21, wherein the central computer gathers information received from multiple mobile units and stores the information for use in one or more of: customer billing; inventory control; cost reporting; accounts payable; payroll; and labor distribution.
